(19) United States
(12) Patent Application Publication
(10) Pub. No.: US 2009/0199604 A1
(43) Pub. Date: Aug. 13, 2009

(54) STEERING LOCK DEVICE FOR COUPLING ELECTRONIC IDENTIFICATION SYSTEM AND METHOD OF MANUFACTURING THEREOF

(76) Inventor: Eung Lyul Kim, Incheon (KR)

Correspondence Address: NIXON & VANDERHYE, PC, 901 NORTH GLEBE ROAD, 11TH FLOOR, ARLINGTON, VA, 22203, US

(21) Appl. No.: 12/303,414

(22) PCT Filed: Apr. 24, 2007
(86) PCT No.: PCT/KR2007/001984

§ 371 Date: Dec. 4, 2008

(30) Foreign Application Priority Data
Jun. 7, 2006 (KR) 10-2006-0051094
Jun. 7, 2006 (KR) 10-2006-0051108

(51) Int. Cl. B60R 25/02; B60R 25/04; B62D 1/16

(52) U.S. Cl. 70/252; 70/255; 29/894.1

(57) ABSTRACT

A steering lock device and method of manufacturing the steering lock device, which is interoperated with an electronic authentication system via minimal structural changes, whose productivity is improved since coupling/decoupling is simple, and whose security against motor vehicle theft is improved, is provided. In the steering lock device, an actuator is coupled with a cam protrusion being coupled with a lock pin, and thereby moves the lock pin. The actuator is operated by an electronic authentication device being carried by a driver, moves the lock pin when receiving a driving signal, and selectively fixes a steering column. Due to the steering lock device and the method of manufacturing the steering device, productivity is improved since coupling/decoupling is simple, and security against motor vehicle theft is improved.

### TECHNICAL FIELD

The present invention relates to a steering lock device and method of manufacturing the steering lock device, which is interoperated with an electronic authentication system. More particularly, the present invention relates to a steering lock device and method of manufacturing the steering lock device, which is interoperated with an electronic authentication system by minimally changing a conventional motor vehicle structure, and has improved productivity and improved security against motor vehicle theft since the steering lock device is easily coupled/decoupled.

### BACKGROUND ART

The federal government of Canada announced that it will be mandatory to install a motor vehicle theft protection device in all motor vehicles produced after Sep. 1, 2007. It is expected that the announcement will affect domestic business in Korea and exporting business to Canada in a motor vehicle manufacturing industry, specifically a manufacturing industry of a motor vehicle theft protection device.

The federal government of Canada is amending Motor Vehicle Safety Regulations, so that a motor vehicle theft protection device is required to be coupled with motor vehicles. The motor vehicle theft protection device is designed to automatically prevent an engine from starting when an unauthorized user tries to start the engine.

In addition to Canada, the trend for coupling the motor vehicle theft protection device is spreading to become a world-wide trend, uses of the motor vehicle theft protection device are expanding, and coupling the motor vehicle theft protection device is becoming a legal obligation.

As an example of the motor vehicle theft protection device, there is a steering lock device to protect motor vehicles from theft. The steering lock device includes a locking groove being formed on a steering shaft, a lock pin capable of being selectively inserted to or separated from the locking groove, and a locking device moving the lock pin. The locking device is generally called an ignition lock device, and includes a key cylinder having a key groove where an ignition key is inserted, a cam being operated by interoperating with the key cylinder, a lock pin being operated by interoperating with the cam, and an ignition switch.

To describe a conventional steering lock device in detail, FIGS. 1 and 2 are illustrated. FIGS. 1 and 2 are cross-sectional views illustrating a steering lock device disclosed in Korean Patent Publication No. 2005-038288.

As illustrated in FIGS. 1 and 2, in a lock device, when a steering column 1 is unlocked, a cam 12 is contacted to an outer surface of a cam receiving space 10 of a lock bar supporting member 5 to securely fix the lock bar supporting member 5, and an engine is in ON mode. In order to stop the engine when the steering column 1 is unlocked, when a key 17 of FIG. 2 is rotated, from the ON mode to LOCK mode via an accessory (ACC) mode, a rotor 9 starts to rotate, a cam control member 11 rotates, and thereby a cam 12 is separated from the outer surface of the cam receiving space 10. Accordingly, the lock bar supporting member 5 is released, and simultaneously, the lock bar supporting member 5 is slid toward the steering column 1 until the lock bar supporting member 5 is engaged with a protrusion 18 by an elastic restoring force of a coil spring 16 being provided between the outer surfaces of the cam receiving unit 10 of the lock bar supporting member 5. Similar to an imaginary line in FIG. 3, a lock pin 6 is inserted to a lock hole 7 being formed on the steering column 1, and thereby locks the column 1.

That is, when a ignition key 17 is inserted to a key cylinder 8 to be rotated, the cam 12 rotates by interoperating with the rotor 9, an ignition switch 14 being coupled with the cam is rotated, and thereby the engine is started or stopped, and simultaneously, a lock pin stopper 5 horizontally reciprocates by interoperating with the cam 12, the lock pin 6 is inserted into or separated from the lock hole 7, and consequently the steering column 1 may perform locking or unlocking. Under predetermined circumstances, the key cylinder 8 and the ignition switch 14, which configure the ignition lock device, may be separated from an ignition body 4 for repairing.

To be compared with a system that uses both mechanical and electronic authentication systems, the above-described steering lock device may be vulnerable to motor vehicle theft since the above-described steering lock device performs authentication processes only mechanically. Also, there may be disadvantages, in that a driver is always required to carry an ignition key to when driving a motor vehicle, and is required to operate a starting device using the ignition key in order to unlock the steering lock device.

Recently, a smart key system capable of starting and operating the engine via an electronic authentication scheme, without the ignition key, is provided. However, great efforts, costs, and time are required to alter to the smart key system. Accordingly, a new steering lock device which can be operated by interoperating with the smart key which uses the electronic authentication device is earnestly required.

### DISCLOSURE OF INVENTION

### Technical Goals

The present invention provides a steering lock device and method of manufacturing the device which can be automatically operated without an ignition key by interoperating with an electronic authentication system, such as a smart key for a motor vehicle.

The present invention also provides a steering lock device and method of manufacturing the device which can be easily coupled/decoupled since the steering lock device is interoperated with an electronic authentication system having minimal structural changes.

The present invention also provides a steering lock device and method of manufacturing the device whose manufacturing costs are reduced and coupling/decoupling is simple, productivity is improved, and security against motor vehicle theft is improved since coupling/decoupling is easy and simple.

### Technical Solutions

According to an aspect of the present invention, there is provided a steering lock device selectively fixing a steering column in a motor vehicle according to movement of a lock pin including: an ignition lock body forming an exterior; an actuator being mounted to one of grooves where an ignition switch and a key cylinder are coupled after eliminating the ignition switch and the key cylinder, and moving the lock pin, the ignition switch and the key cylinder being coupled with the ignition lock body; and a protective cover being coupled with the other grooves where the ignition switch and the key cylinder are mounted, and closing the other grooves so that the ignition key cannot be inserted, wherein the actuator moves the lock pin by an electrical signal being transmitted from an outside of a motor vehicle so that the steering column is locked or unlocked.

The actuator includes: a housing; a motor being provided in the housing and generating a driving force; a gear unit transmitting the driving force of the motor; and a rotation unit, wherein an end of the rotation unit is coupled with the gear unit, and a slit is coupled with a cam protrusion, the cam protrusion being capable of moving the lock pin formed on the other end of the rotation unit.

The steering lock device of the present invention is interoperated with an electronic authentication device which automatically transmits the electrical signal via communication when a driver approaches the motor vehicle to be within a predetermined distance due to the electronic authentication device being carried by the driver.

According to another aspect of the present invention, there is provided a method of manufacturing a steering lock device selectively fixing a steering column in a motor vehicle according to movement of a lock pin including: providing an actuator which is operated by an electrical signal being transmitted from an outside of the motor vehicle; separating a key cylinder and an ignition switch from an ignition lock body of the motor vehicle; coupling the actuator with one of grooves where the ignition switch and the key cylinder are coupled; and closing another groove from the grooves where the ignition switch and the key cylinder are coupled, wherein the actuator moves a lock pin by an electrical signal being transmitted from the outside of the motor vehicle.

### BRIEF DESCRIPTION OF DRAWINGS

FIGS. 1 and 2 are cross-sectional views illustrating a steering lock device disclosed in Korean Patent Publication No. 2005-038288;

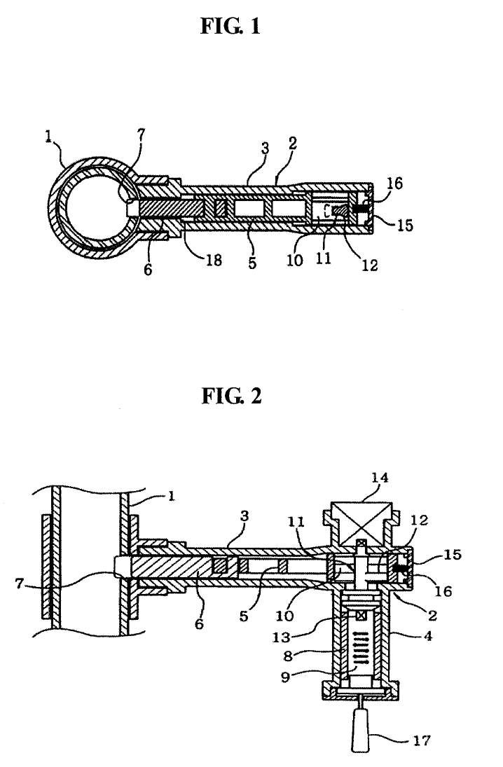

FIG. 3 is an exploded-perspective view illustrating a steering lock according to a first embodiment of the present invention;

FIG. 4 is a cross-sectional view illustrating an actuator according to the first embodiment of the present invention;

FIG. 5 is a cross-sectional view illustrating that a steering shaft is locked by a lock pin according to the first embodiment of the present invention;

FIG. 6 is a cross-sectional view illustrating that the steering shaft is unlocked after the lock pin is receded according to the first embodiment of the present invention;

FIG. 7 is a block diagram illustrating an applied example of an actuator according to the first embodiment of the present invention;

FIG. 8 is an exploded-perspective view illustrating a steering lock device according to a second embodiment of the present invention;

FIG. 9 is a cross-sectional view illustrating an actuator according to the second embodiment of the present invention;

FIG. 10 is a cross-sectional view illustrating that a steering shaft is locked by a lock pin according to the second embodiment of the present invention; and

FIG. 11 is a cross-sectional view illustrating that the steering shaft is unlocked by the lock pin according to the second embodiment of the present invention.

### BEST MODE FOR CARRYING OUT THE INVENTION

### First Embodiment

Although the present invention has been described in connection with the embodiment of the present invention illustrated in the accompanying drawings, it is not limited thereto.

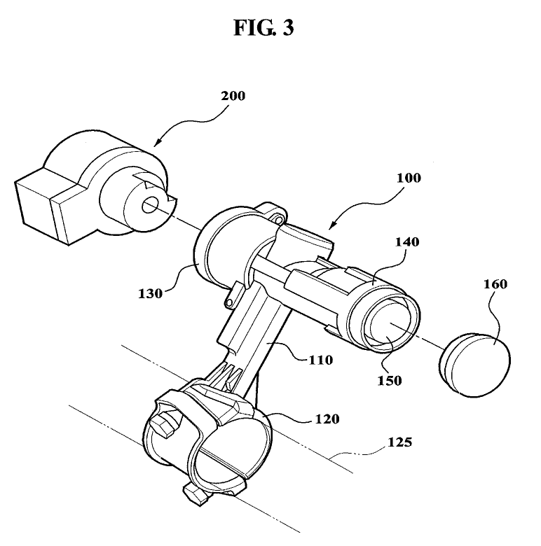

FIG. 3 is an exploded-perspective view illustrating a steering lock according to a first embodiment of the present invention.

As illustrated in FIG. 3, a shaft receiving unit 120 is provided on a lower portion of a main body 110 of an ignition lock body 100, the shaft receiving unit 120 being formed in a doughnut shape, having a steering shaft 125 passed through therein. Also, an actuator mounting groove 130 is provided on a side of an upper portion of the main body 110 so that an actuator 200 is mounted to the main body 110. A key cylinder receiving groove 140 receiving a cylinder 150 is formed in a direction which faces the actuator mounting groove 130.

By including a locking groove, the steering shaft 125 is locked or unlocked via a lock pin, the lock pin being moved by the actuator 200. The locking groove of the steering shaft 125 is formed on an area of the steering shaft 125, is encircled by the shaft receiving unit 120, and the steering shaft 125 is locked since the lock pin is coupled with the locking groove, the lock pin being protruded from the main body 110 toward the shaft receiving unit 120.

In motor vehicles to be unlocked, a key cylinder where a key is inserted and a rotor being mounted to the key cylinder are coupled with a key cylinder receiving groove 140. In a steering lock device 100 of the present invention, the key cylinder and the rotor are removed so that a control from an outside by using a key is not possible. A protective cover 160 is coupled with the key cylinder receiving groove 140 to prevent interference from an outside. Also, after a cylinder 150 may be inserted into the key cylinder receiving groove 140, the protective cover 160 may be coupled with the key cylinder receiving groove 140, and the key cylinder receiving groove 140 is closed.

The actuator 200 is coupled with the actuator mounting groove 130, and an ignition switch is coupled with the actuator mounting groove 130 in motor vehicles to be released. When the actuator 200 is needed to be mounted after being released, the ignition switch is removed, and the actuator 200 is inserted.

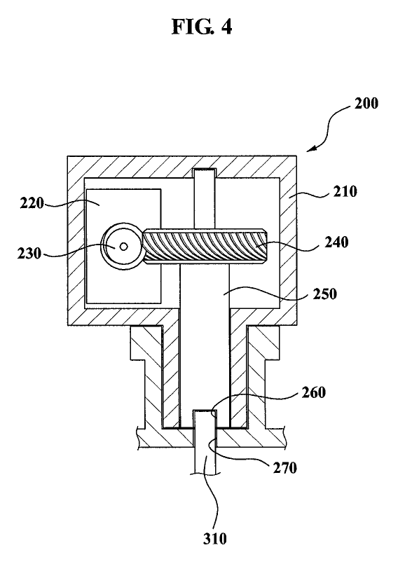

For detailed description of the actuator 200, FIG. 4 is provided. FIG. 4 is a cross-sectional view illustrating the actuator 200 according to the first embodiment of the present invention.

As illustrated in FIG. 4, the actuator 200 includes a housing 210, a motor 220 being provided in the housing 210 and generating a driving force, a first gear 230 being connected with an axis of the motor 220, a second gear 240 being connected with the first gear 230 and changing a direction of the driving force to a vertical direction, and a rotation unit 250 being connected with the second gear 240.

The first gear 230 and the second gear 240 may be general worm gears that change the driving force to a vertical direction, and transmit the changed driving force. An end of the rotation unit 250 is connected with the second gear 240, and a slit 260 is formed on the other end of the rotation unit 250, the slit 260 being exposed via a penetration hole 270 of the housing 210. The slit 260 may be formed in a rectangular shape or an oval shape so that a major axis and a minor axis are distinguished from each other. The slit 260 is coupled with a cam protrusion to move a lock pin forwards or backwards, which will be described later.

When the motor 220 rotates, the first gear 230 and the second gear 240 rotate, and thereby the rotation unit 250 rotates by a predetermined angle. Accordingly, the slit 260 being formed on the rotation unit 250 rotates by a predetermined angle. The motor 220 transmits the driving force in a clockwise direction or in a counterclockwise direction, and thereby rotates the slit 260 in the clockwise direction or in the counterclockwise direction.

The motor 220 generates the driving force using a power of the motor vehicle, or using an additional battery. The motor 220 is operated by an electrical signal being transmitted from an outside of the motor vehicle, and an electronic authentication device of the motor vehicle such as a smart key may be taken as an example of the apparatus that generates the driving force.

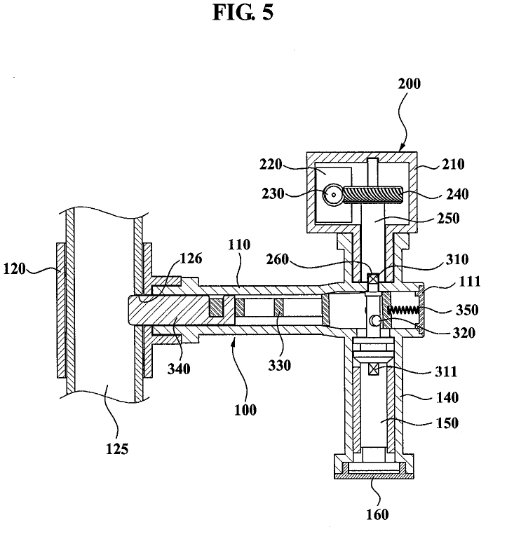

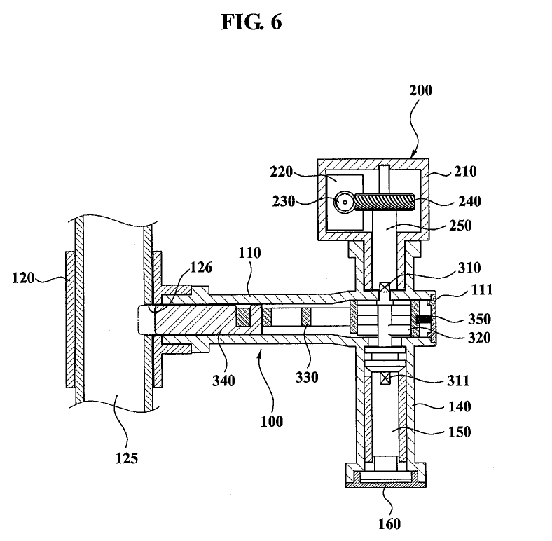

FIGS. 5 and 6 are provided to describe an entire operational theory of the present invention.

FIG. 5 is a cross-sectional view illustrating that a steering shaft 125 is locked by a lock pin 340 according to the first embodiment of the present invention, and FIG. 6 is a cross-sectional view illustrating that the steering shaft 125 is unlocked after the lock pin 340 is receded according to the first embodiment of the present invention.

As illustrated in FIG. 5, the lock pin 340 is provided inside a main body 110 of the steering lock device 100, the lock pin 340 being coupled with a locking groove 126, which forms the steering shaft 125. The lock pin 340 is connected with a lock pin stopper 330, and the lock pin stopper 330 is contacted to a cam 320. A spring 350 is provided on an end of the lock pin stopper 330, and thereby transmits an elastic force. In this instance, the spring 350 may be compressively mounted for its initial establishment location. Also, when an actuator 200 is not operating, it is desirable that the lock pin 340 is required to be inserted to the locking groove 126 by pressing the lock pin stopper 330.

When a driver approaches a motor vehicle to be within a predetermined distance, a driving electrical signal for a motor 220 is generated from an electronic authentication device being carried by the driver to be transmitted to the motor 220 of the actuator 200, and the motor 220 receives the driving electrical signal to rotate in a single direction as illustrated in FIG. 6.

A driving force being generated from the motor 220 rotates a slit 260 in a single direction via a first gear 230 and a second gear 240, and thereby a cam protrusion 310, which is coupled with the slit 260, is rotated. As a result that the cam protrusion 310 is rotated, the cam 320, which is connected with the cam protrusion 310, is rotated.

As a result that the cam 320 is rotated, the lock pin stopper 330 horizontally recedes, the lock pin 340 recedes, and thereby the lock pin 340 is separated from the locking groove 126 being formed on the steering shaft 125. Therefore, the steering shaft 125 is unlocked, and is able to rotate according to manipulation of a handle of the driver. A reference number 111 indicates a spring supporting wall, and a reference number 311 indicates another cam protrusion being mounted on a key cylinder.

A method of manufacturing the steering lock device of the present invention is as follows:

Initially, a housing 210 is manufactured, subsequently the motor 220, the first gear 230, and second gear 240 are synthesized in an inside of the housing 210, and a rotation unit 250, which is provided with the slit 260, is coupled thereon, and the actuator 200 is completed.

Next, a key cylinder and an ignition switch are separated from an actuator mounting groove 130 and a key cylinder receiving groove 140. The operation of the separating the key cylinder and the ignition switch is well-known technique in the field of the art, specifically, a key is inserted into a key groove to turn the inserted key to an ACC mode, and a protrusion of the key cylinder is pressed, subsequently the key cylinder and the ignition switch may be separated from an ignition lock body.

Next, the actuator 200 is inserted to be coupled with the actuator mounting groove 130 where the ignition switch exists. In this instance, the slit 260 of the actuator 200 is coupled with the cam protrusion 310. Also, a cylinder 150 is inserted to the key cylinder receiving groove 140 where the key cylinder has existed, and the key cylinder receiving groove 140 is closed by attaching a protective cover 160.

As illustrated above, the steering lock of the present invention may be locked or unlocked by easily interoperating with an electronic authentication device since a structural change from a conventional motor vehicle structure is minimized. Also, coupling/decoupling is simple, there is no need to carry an ignition key, and improved security against motor vehicle theft may be provided.

In the specification of the present invention, the electronic authentication device indicates all types of devices that can close/open doors of the motor vehicle, or start an engine without using the key of the motor vehicle, for example, the electronic authentication device indicates all types of devices that can be automatically controlled via communication when the driver approaches the vehicle to be within a predetermined distance. Specifically, an electrical signal may be generated since the driver manually operates a remote control starting device to generate a driving electrical signal for a motor, or the electrical signal may be generated using short range communication via a device embedded with radio frequency identification (RFID), when the driver approaches the motor vehicle to be within a predetermined distance, or the electrical signal may be generated using Bluetooth or infrared data communication (IrDA). Also, the driving electrical signal of the motor may be generated by interoperating a push button for starting an engine.

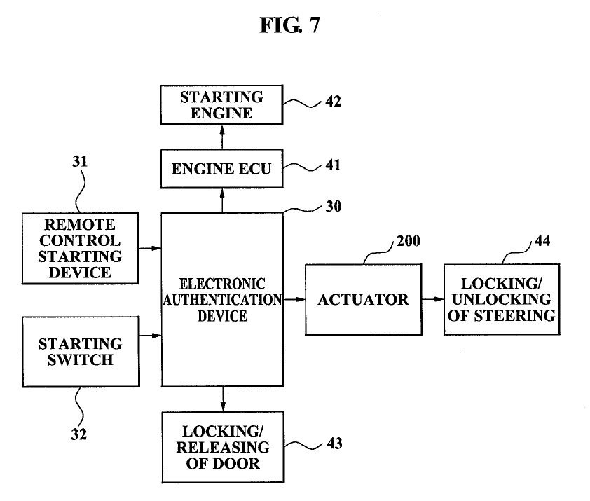

An example of operation of the electronic authentication device is illustrated in FIG. 7. The FIG. 7 is a block diagram illustrating an applied example of an actuator according to the first embodiment of the present invention. An electronic authentication device 30 receives an electrical signal via a remote control starting device 31 or a starting switch 32. As described above, the remote control starting device 31 may indicate all types of devices that can be automatically controlled via communication when a driver approaches a vehicle to be within a predetermined distance, including a remote controller.

The starting switch 32 may be a general starting switch type, and also may be a starting switch of a push button type. A control signal is inputted to the electronic authentication device 30 according to an ACC/ON/START mode, accordingly an outputted control signal of the electronic authentication device 30 may differ.

The electronic authentication device 30 controls starting of an engine 42, locking/releasing of a door 43, locking/unlocking of a steering 44 that uses the actuator 200 of FIG. 6, and a sequence of the controlling may be variously configured. As an example, after the releasing of the door 43 by receiving a signal of the remote control starting device 31, the unlocking of the steering or the starting of the engine 42 may be performed by receiving a signal of the starting switch 32. Alternatively, the locking/unlocking of the steering may be controlled according to the ACC/ON/START mode. The starting of the engine 42 may be performed by operating an ignition switch via an engine electronic control unit (ECU) 41.

### Second Embodiment

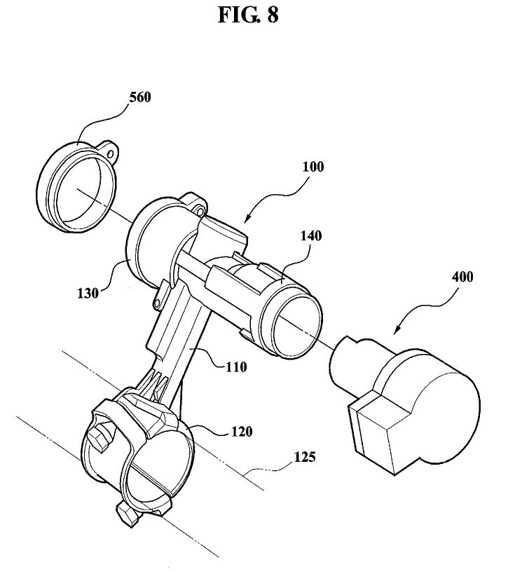

FIG. 8 is an exploded-perspective view illustrating a steering lock device according to a second embodiment of the present invention.

An ignition lock body 100 is provided with a main body 110, and a shaft receiving unit 120 being formed in a doughnut shape is provided on a lower portion of the main body 110, the shaft receiving unit 120 having a steering shaft 125 passed through therein. Also, an actuator mounting groove 140 is provided on a side of an upper portion of the main body 110, and an ignition switch receiving groove 130 is formed in a direction which faces the actuator mounting groove 140, the ignition switch receiving groove 130 being removed from an ignition switch. The ignition switch receiving groove 130 may be closed using a cover 560. A cylinder is inserted into the ignition switch receiving groove 130, and thereby foreign substances may not be inserted into the ignition switch receiving groove 130, and interference from an outside may be prevented.

Similar to the first embodiment, the steering shaft 125 is locked or unlocked via a lock pin by including a locking groove, the lock pin being moved by the actuator 400.

In motor vehicles to be unlocked, a key cylinder where a key is inserted, and a rotor being mounted to the key cylinder are coupled with actuator mounting groove 140. In the steering lock device 100 of the present invention, the key cylinder and the rotor are removed, and the actuator 400 is coupled, the actuator 400 capable of being operated by a signal from an outside.

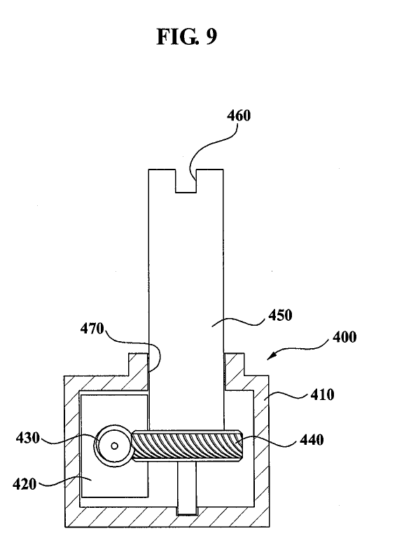

For detailed description of the actuator 400, FIG. 9 is provided. FIG. 9 is a cross-sectional view illustrating the actuator 400 according to a second embodiment of the present invention.

As illustrated in FIG. 4, the actuator 400 includes a housing 410 being formed with a penetration hole 470 on a side thereof, a motor 420 being provided in the housing 410 and generating a driving force, a first gear 430 being connected with an axis of the motor 420, a second gear 440 being connected with the first gear 430 and changing a direction of the driving force to a vertical direction, and a rotation unit 450 being connected with the second gear 440. Description regarding the actuator 400 will be omitted since the description the actuator 400 is identical to the description given in the first embodiment.

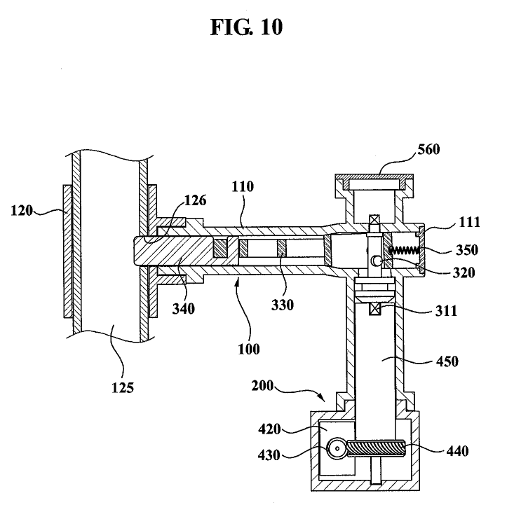

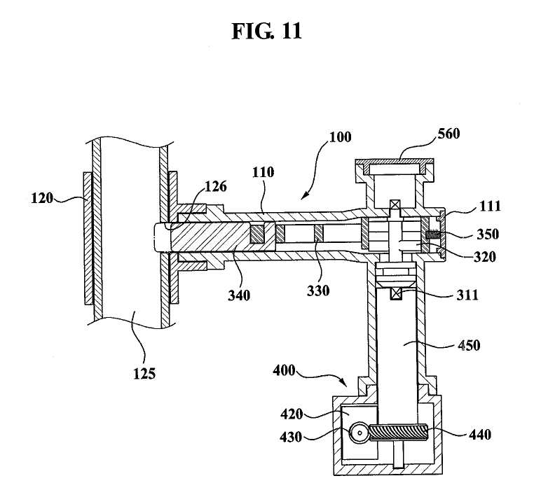

To describe an entire operational theory of the present invention, FIGS. 10 and 11 are provided. FIG. 10 is a cross-sectional view illustrating that a steering shaft is locked by a lock pin according to the second embodiment of the present invention, and FIG. 11 is a cross-sectional view illustrating that the steering shaft is unlocked by receding of the lock pin according to the second embodiment of the present invention.

As illustrated in FIG. 10, a lock pin 340 is installed inside of a main body 110 of a steering lock device 100, the lock pin 340 being coupled with a locking groove 126 on a steering shaft 125. The lock pin 340 is connected with a lock pin stopper 330, and the lock stopper 330 is contacted to a cam 320. A spring 350 is provided on an end of the lock pin stopper 330, and thereby transmits an elastic force.

When a driver approaches a motor vehicle to be within a predetermined distance, an electrical signal for a motor 420 is generated from an electronic authentication device being carried by the driver, the generated electrical signal is transmitted to the motor 420 of the actuator 400, the motor 420 receives the generated electrical signal, and thereby rotates in a single direction, as illustrated in FIG. 11. The driving force being generated from the motor 420 rotates a slit 460 in a single direction via a first gear 430 and a second gear 440, and thereby rotates a cam protrusion 311 being coupled with the slit 560. When the cam protrusion 311 is rotated, the cam 320 is rotated since the cam 320 is connected with the cam protrusion 311.

As a result that the cam 320 is rotated, the lock pin stopper 330 horizontally recedes, and thereby separates the lock pin 340 from the locking groove 126 being formed on the steering shaft 125. Therefore, the steering shaft 125 is unlocked, and is able to rotate according to manipulation of a handle of the driver. A reference number 111 indicates a spring supporting wall, and a reference number 310 indicates another cam protrusion being mounted on an ignition switch receiving grove 130.

A method of manufacturing the steering lock device of the present invention is as follows:

Initially, a housing 210 is manufactured, subsequently the motor 420, the first gear 430, and second gear 440 are synthesized in an inside of the housing 210, and a rotation unit 450, which is provided with the slit 460, is coupled thereon, and the actuator 400 is completed.

Next, a key cylinder and an ignition switch are separated from an actuator mounting groove 140 and an ignition switch receiving groove 130. The operation of the separating of the key cylinder and the ignition switch is well-known technique in the field of the art, specifically, a key is inserted to a key groove to turn the inserted key to an ACC mode, and a protrusion of the key cylinder is pressed, subsequently the key cylinder and the ignition switch may be separated from an ignition lock body.

Next, the actuator 400 is inserted to be coupled with the actuator mounting groove 140. In this instance, the slit 460 of the actuator 400 is coupled with the cam protrusion 311. Also, a cylinder is inserted into the ignition switch groove 130 where the ignition switch exists, and the ignition switch groove 130 is closed by attaching a protective cover 160.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

### INDUSTRIAL APPLICABILITY

As illustrated in above, according to the present invention, there is provided a steering lock device which can be operated without an ignition key by interoperating with an electronic authentication system, such as a smart key for a motor vehicle.

Also, according to the present invention, there is provided a steering lock device which can be easily coupled/decoupled since the steering lock device is interoperated with an electronic authentication system having minimal structural changes.

Also, according to the present invention, there is provided a steering lock device whose productivity is improved, manufacturing costs are reduced, and coupling/decoupling is simple.

Also, according to the present invention, there is provided a steering lock device which can improve security against motor vehicle theft since a steering lock device is easily interoperated with an electronic authentication device.

1. A steering lock device selectively fixing a steering column in a motor vehicle according to movement of a lock pin, comprising:
an ignition lock body forming an exterior;
an actuator being mounted to one of grooves where an ignition switch and a key cylinder are coupled after removed the ignition switch and the key cylinder, and moving the lock pin, the ignition switch and the key cylinder being coupled with the ignition lock body; and
a protective cover being coupled with the other grooves where the ignition switch and the key cylinder are mounted, and closing the other grooves so that the ignition key cannot be inserted,
wherein the actuator moves the lock pin by an electrical signal being transmitted from an outside of a motor vehicle so that the steering column is locked or unlocked.

2. The steering lock device of claim 1, wherein the actuator comprises:
a housing;
a motor being provided in the housing and generating a driving force;
a gear unit transmitting the driving force of the motor; and
a rotation unit,
wherein an end of the rotation unit is coupled with the gear unit, and a slit is coupled with a cam protrusion, the cam protrusion being capable of moving the lock pin formed on the other end of the rotation unit.

3. The steering lock device of claim 1, further comprises:
an electronic authentication device,
wherein the electronic authentication device automatically transmits the electrical signal via communication when a driver approaches the motor vehicle to be within a predetermined distance due to the electronic authentication device being carried by the driver.

4. The steering lock device of claim 1, wherein the electronic authentication device controls the actuator according to an ACC/ON/START mode of the ignition switch to perform steering locking or steering unlocking, and controls an engine electronic control unit (ECU) to start the engine.

5. A method of manufacturing a steering lock device selectively fixing a steering column in a motor vehicle according to movement of a lock pin, comprising:
providing an actuator which is operated by an electrical signal being transmitted from an outside of the motor vehicle;
separating a key cylinder and an ignition switch from an ignition lock body of the motor vehicle;
coupling the actuator with one of grooves where the ignition switch and the key cylinder are coupled; and
closing another groove from the grooves where the ignition switch and the key cylinder are coupled,
wherein the actuator moves a lock pin by an electrical signal being transmitted from the outside of the motor vehicle.

6. The method of claim 5, wherein the providing of the actuator comprises:
providing a housing;
receiving a motor in an inside of the housing;
coupling a gear unit which transmits a driving force; and
providing a rotation unit,
wherein an end of the rotation unit is coupled with the gear unit, a slit being coupled with a cam protrusion and the cam protrusion capable of moving the lock pin are formed on another end of the rotation unit.

7. The method of claim 5, further comprises:
providing an electronic authentication device,
wherein the electronic controlling device automatically transmits the electrical signal via communication when a driver approaches the motor vehicle to be within a predetermined distance due to the electronic authentication device being carried by the driver.

8. The method of claim 7, wherein the electronic authentication device controls the actuator according to an ACC/ON/START mode of the ignition switch to perform steering locking or steering unlocking, and controls the electronic control unit of an engine to start the engine.
